(19) United States
(12) Patent Application Publication
(10) Pub. No.: US 2010/0089674 A1
(43) Pub. Date: Apr. 15, 2010

(54) Tractor

(75) Inventors: Yozo Oka, Osaka (JP); Noboru Yamamoto, Osaka (JP); Katsuzo Kato, Osaka (JP)

Correspondence Address: JORDAN AND HAMBURG LLP, 122 EAST 42ND STREET, SUITE 4000, NEW YORK, NY, 10168, US

(73) Assignee: YANMAR CO., Ltd., Osaka-shi (JP)

(21) Appl. No.: 11/989,655

(22) PCT Filed: Jan. 4, 2006
(86) PCT No.: PCT/JP2006/300015

§ 371 Date: Jan. 29, 2008

(30) Foreign Application Priority Data
Aug. 29, 2005 (JP) 2005-248397

(51) Int. Cl. B60K 11/00

(52) U.S. Cl. 180/68.1

(57) ABSTRACT

The present invention is provided for sufficiently ensuring a heat balance in the inside of a bonnet. In a tractor in which a radiator including an outside-air suction fan is arranged frontward of an engine, the radiator and the outside-air suction fan are covered with a bonnet, and the outside air is sucked by the outside-air suction fan through a front grille portion formed in the bonnet thus cooling the radiator, a radiator cooling air discharge opening portion is formed in a side wall portion of the bonnet, and the radiator cooling air discharge opening portion opens in the rearward direction.

### BACKGROUND OF THE INVENTION

1. Field of the Invention

The present invention relates to a tractor which forms a radiator cooling air discharge opening portion in a side wall portion of a bonnet.

2. Description of the Related Art

Conventionally, as one mode of a tractor, there has been known a tractor in which a radiator having an outside-air suction fan is arranged frontward of an engine, the radiator and the outside-air suction fan are covered with a bonnet and, further, the outside air is sucked using the outside-air suction fan through a front grille portion mounted on the bonnet so as to cool the radiator (for example, see JP-A-7-17439 (patent document 1)).

Further, a discharge grille for discharging radiator cooling air is formed in a side wall portion of the bonnet so as to discharge the radiator cooling air to the outside of the tractor through the discharge grille.

However, the radiator cooling air which flows rearwardly from a front side flows along the side wall portions of the bonnet and hence, a positional relationship between the radiator cooling air and the discharge grille formed in the side wall portion assumes a substantially parallel state thus giving rise to a drawback that it is difficult to discharge the radiator cooling air through the discharge grille. Accordingly, there exists a possibility that a heat balance in the inside of the bonnet cannot be sufficiently ensured.

### SUMMARY OF THE INVENTION

(1) According to a first aspect of the present invention, there is provided a tractor in which a radiator including an outside-air suction fan is arranged frontward of an engine, the radiator and the outside-air suction fan are covered with a bonnet, and the outside air is sucked by the outside-air suction fan through a front grille portion formed in the bonnet thus cooling the radiator, wherein a radiator cooling air discharge opening portion is formed in a side wall portion of the bonnet, and the radiator cooling air discharge opening portion opens in the rearward direction.

Due to such a constitution, the radiator cooling air discharge opening portion formed in the side wall portion of the bonnet opens rearwardly and hence, the radiator cooling air which flows rearwardly from a front side flows along the side wall portion of the bonnet and, at the same time, is smoothly discharged to the outside of the tractor through the radiator cooling air discharge opening portion.

As a result, a heat balance in the inside of the bonnet can be sufficiently ensured thus enhancing the cooling performance of the radiator.

(2) According to a second aspect of the present invention, in the above-mentioned tractor, a stepped recessed portion which has a front portion thereof arranged on an outer side of the bonnet and a rear portion thereof arranged on an inner side of the bonnet is formed on the side wall portion of the bonnet, the radiator cooling air discharge opening portion is formed in an end surface of a stepped portion of the stepped recessed portion, and a guide surface portion for guiding a radiator cooling air which is discharged through the radiator cooling air discharge opening portion is formed on the side wall portion of the bonnet arranged rearward of the radiator cooling air discharge opening portion, and the guide surface portion is formed of an inclined surface which extends toward a rear side from a front side with the rear side gradually bulging outwardly.

Due to such a constitution, the guide surface portion formed on the side wall portion of the bonnet arranged rearward of the radiator cooling air discharge opening portion is formed of the inclined surface which extends toward a rear side from a front side with the rear side gradually bulging outwardly and hence, it is possible to form a discharge passage which allows the cooling air discharged through the radiator cooling air discharge opening portion to flow smoothly while guiding the cooling air rearwardly and outwardly along the guide surface portion.

Further, it is possible to prevent the radiator cooling air discharged through the radiator cooling air discharge opening portion from impinging on a face of an operator or the like who operates the tractor while sitting on a driver portion arranged rearward of the radiator.

As a result, it is possible to enhance the heat balance property in the inside of the bonnet and, at the same time, a driving operation circumstance of the operator can be sufficiently ensured.

(3) According to a third aspect of the present invention, in the above-mentioned tractor, the radiator cooling air discharge opening portion is formed in the vertically extending manner with a width thereof gradually increased toward a lower end portion thereof from an upper end portion thereof.

Due to such a constitution, the width of the radiator cooling air discharge opening portion formed in the vertically extending manner is gradually increased as toward the upper end portion thereof from the lower end portion thereof and hence, it is possible to guide the radiator cooling air discharged to the outside of the tractor through the radiator cooling air discharge opening portion rearwardly and downwardly.

Accordingly, also from this viewpoint, it is possible to prevent the radiator cooling air discharged through the radiator cooling air discharge opening portion from impinging on a face of an operator or the like who operates the tractor while sitting on a driver portion arranged rearward of the radiator.

As a result, it is possible to enhance the heat balance property in the inside of the bonnet and, at the same time, a driving operation circumstance of the operator can be more sufficiently ensured.

### BRIEF EXPLANATION OF DRAWINGS

FIG. 1 is a side view of a tractor according to the present invention;

FIG. 2 is a planar explanatory view of a prime mover part of the tractor;

FIG. 3 is a perspective explanatory view of a bonnet of the tractor; and

FIG. 4 is an explanatory cross-sectional view of a back surface of the bonnet.

### PREFERRED EMBODIMENTS OF THE PRESENT INVENTION

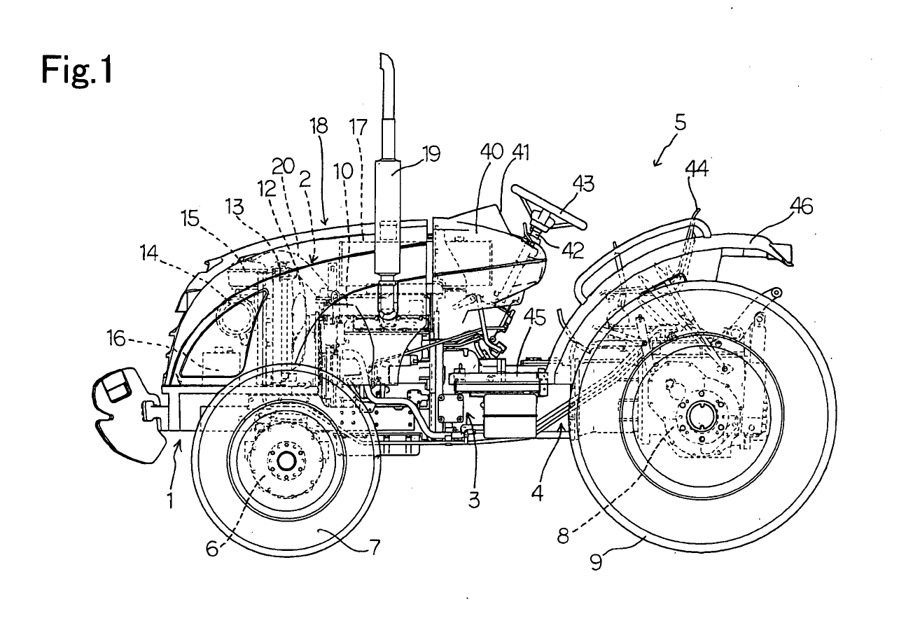

Symbol A shown in FIG. 1 indicates a tractor according to the present invention. In the tractor A, a prime mover part 2 is mounted on a body frame 1, a transmission portion 4 is interlockingly connected to the prime mover part 2 by way of a clutch portion 3, a driver portion 5 is arranged on the transmission portion 4, a pair of left and right front wheels 7, 7 is interlockingly connected to a lower portion of the body frame 1 by way of a front axle case 6, and a pair of left and right rear wheels 9, 9 is interlockingly connected to the transmission portion 4 by way of a rear axle cases 8, 8.

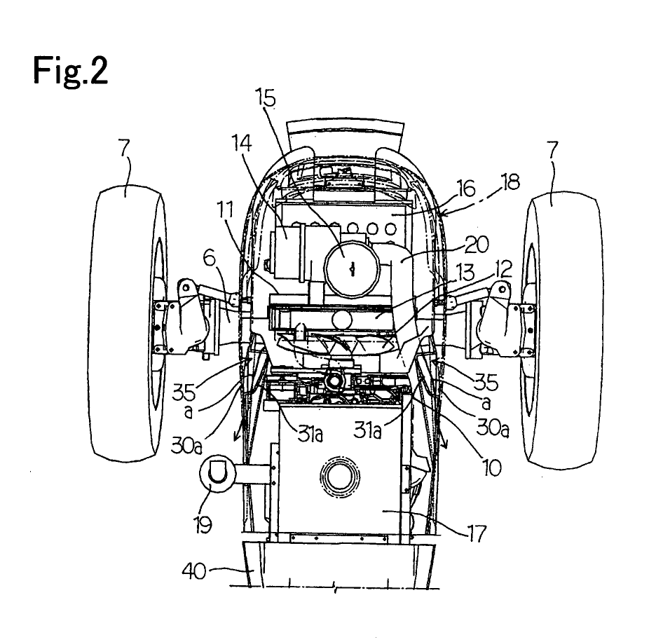

In the prime mover part 2, also as shown in FIG. 2, an engine 10 is mounted on the body frame 1, a radiator 13 including an outside-air suction fan 12 is arranged at a position directly frontward of the engine 10 by way of a support frame body 11, an air cleaner 14 is arranged at a position directly frontward of the radiator 13 by way of the support frame body 11, a precleaner 15 is arranged at a position directly above the air cleaner 14, while a battery 16 is arranged at a position directly below the air cleaner 14, and a fuel tank 17 formed in the longitudinally extending manner is arranged at a position directly above the engine 10. These portions are covered with a bonnet 18 in an openable manner. Numeral 19 indicates a muffler, and numeral 20 indicates an air supply pipe.

Due to such a constitution, in the prime mover part 2, it is possible to cool the radiator 13 by sucking the outside air by the outside-air suction fan 12 through a front grille portion described later which is mounted on the bonnet 18.

The bonnet 18 is, as shown in FIG. 1 to FIG. 4, constituted of a ceiling portion 21 formed in a slightly downwardly curved shape in the frontward direction, a front upper portion 22 formed into a quarter-arcuate shape by bending a front end portion of the ceiling portion 21, a front wall portion 23 formed in a downwardly extending manner from a lower end portion of the front upper portion 22, and left and right side wall portions 24, 24 which are contiguously formed with left and right peripheral portions of the front wall portion 23 and left and right end portions of the ceiling portion 21 in a smoothly curved manner.

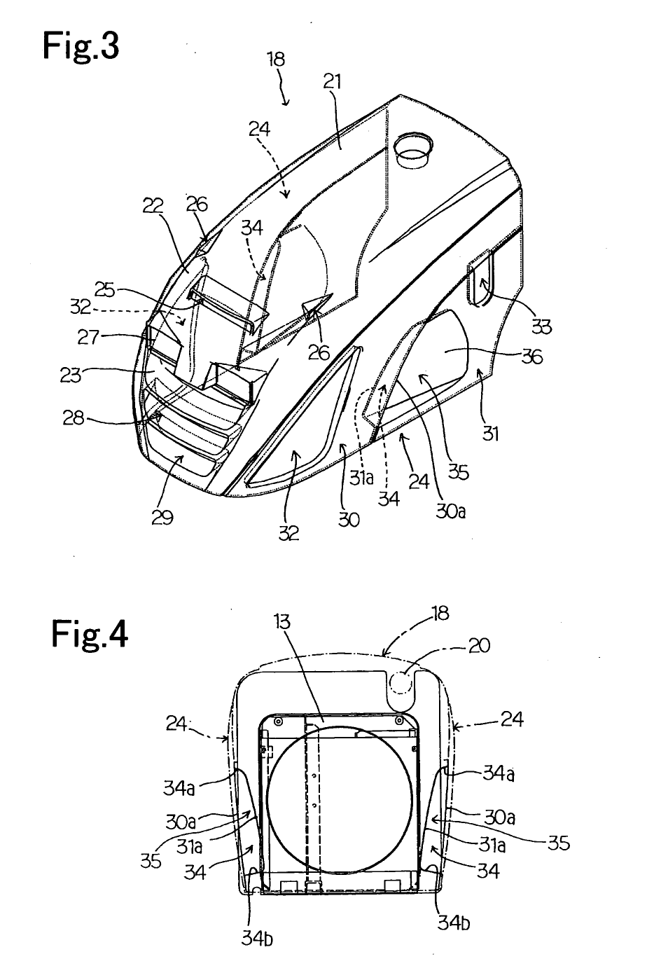

Further, as shown in FIG. 3, in the front upper portion 22, a viewing portion 25 through which the inside of the bonnet 18 can be viewed from a front side of a tractor body is formed and, at the same time, light introducing windows portions 26, 26 which can introduce light into the inside of the bonnet 18 from left and right sides of the front portion of the bonnet 18 are formed in left and right portions of the front portion of the ceiling portion 21.

Due to such a constitution, light is introduced into the inside of the bonnet 18 through the light introducing window portions 26, 26 and hence, the inside of the bonnet 18, particularly, a dust collecting state or a dust storing state of the pre-cleaner 15 can be easily viewed through the view portion 25.

Further, as shown in FIG. 1 and FIG. 3, a pair of left and right head lights 27, 27 is mounted an upper portion of the front wall portion 23, and an upper-stage intake opening portion 28 and a lower-stage intake opening portion 29 which constitute a front grille are arranged in two stages below the respective head lights 27, 27, and a net body (not shown in the drawing) is extended over the respective intake opening portions 28, 29.

Each of left and right side wall portions 24, 24 is, as shown in FIG. 1 to FIG. 4, formed of a front-half side wall forming body 30, 30 and a rear-half side wall forming body 31, 31. Each front-half side wall forming body 30, 30 is constituted by integrally forming a front half portion of each side wall portion 24, 24 and each rear half upper end portion of the each side wall portions 24, 24. Each front-half side wall forming body 30, 30 is connected to respective side end portions of the ceiling portion 21, the front upper portion 22 and the front wall portion 23. On the other hand, the rear-half side wall forming bodies 31, 31 are detachably mounted on the body frame 1 in an erected manner.

Further, a side intake opening portion 32 is formed in the front-half side wall forming body 30, and a net body (not shown in the drawing) is extended over the intake opening portion 32. Numeral 33 indicates a muffler inserting notched port formed in the left-side rear-half side wall forming body 31.

In the above-mentioned constitution, the gist of the present invention lies in that radiator cooling air discharge opening portions 34, 34 are formed in the left and right side wall portions 24, 24 of the bonnet 18 and, at the same time, the radiator cooling air discharge opening portions 34, 34 are formed to open in the rearward direction.

That is, in the left and right side wall portions 24, 24 of the bonnet 18, stepped recessed portions 35, 35 are formed on front half portions of the rear-half side wall forming bodies 31, 31 such that rear end peripheral portions 30a, 30a of the front-half side wall forming bodies 30, 30 are positioned on an outer side of the bonnet 18 and front end portions 31a, 31a of the rear-half side wall forming bodies 31, 31 are positioned on an inner side of the bonnet 18. Due to such a constitution, each radiator cooling air discharge opening portion 34, 34 opening in the rearward direction is formed by the rear end peripheral portions 30a, 30a of the front-half side wall forming body 30, 30 and the front end peripheral portion 31a, 31a of the rear-half side wall forming body 31, 31.

Further, guide surface portions 36, 36 for guiding the radiator cooling air which is discharged through the respective radiator cooling air discharge opening portions 34, 34 are formed in the stepped recessed portions 35, 35 of the rear-half side wall forming bodies 31, 31 positioned rearward of the radiator cooling air discharge opening portions 34, 34, and each guide surface portion 36 has an inclined surface which extends toward a rear side from a front side with the rear side gradually bulging outwardly.

Further, the radiator cooling air discharge opening portions 34, 34 are formed in the vertically extending manner and, at the same time, a width of each radiator cooling air discharge opening portions 34, 34 is gradually increased toward a lower end portion 34b, 34b thereof from an upper end portion 34a thereof.

As described above, in this embodiment, the radiator cooling air discharge opening portions 34, 34 formed in the left and right side wall portions 24, 24 of the bonnet 18 open in the rearward direction and hence, the radiator cooling air which flows toward the rear side from the front side flows along the left and right side wall portions 24, 24 of the bonnet 18 and, at the same time, are smoothly discharged to the outside of the tractor through the radiator cooling air discharge opening portions 34, 34. Symbol “a” indicates a flowing direction of the radiator cooling air.

As a result, a heat balance in the inside of the bonnet 18 can be sufficiently ensured and hence, it is possible to enhance the cooling performance of the radiator 13.

Further, the guide surface portion 36, 36 formed on the stepped recessed portions 35, 35 arranged rearward of the radiator cooling air discharge opening portions 34, 34 has the inclined surface extending toward the rear side from the front side with the rear side gradually bulging outwardly. Accordingly, it is possible to form a discharge passage which allows the cooling air discharged through the radiator cooling air discharge opening portions 34, 34 to smoothly flow while guiding the cooling air rearwardly and outwardly along the guide surface portions 36, 36.

Further, it is possible to prevent the radiator cooling air discharged through the radiator cooling air discharge opening portions 34, 34 from impinging on a face or the like of an operator who operates the tractor while sitting on the driver portion 5 arranged on a rear side of the tractor.

As a result, it is possible to enhance the heat balance property in the inside of the bonnet 18 and, at the same time, a driving operation circumstance of the operator can be sufficiently ensured.

Further, the radiator cooling air discharge opening portion 34, 34 formed in the vertically extending manner is formed with the width thereof gradually increased toward the lower end portions 34b, 34b thereof from the upper end portions 34a, 34a thereof. Accordingly, it is possible to guide the radiator cooling air discharged through the radiator cooling air discharge opening portions 34, 34 to the outside of the tractor rearwardly and downwardly.

Accordingly, also from this viewpoint, it is possible to prevent the radiator cooling air discharged through the radiator cooling air discharge opening portions 34, 34 from impinging on the face or the like of an operator who operates the tractor while sitting on the driver portion 5 arranged on the rear side of the tractor.

As a result, it is possible to enhance the heat balance property in the inside of the bonnet 18 and, at the same time, the driving operation circumstance of the operator can be more sufficiently ensured.

In the driver portion 5, as shown in FIG. 1, a dashboard 40 is arranged to close a rear end opening portion of the bonnet 18 mounted on the prime mover part 2, a meter panel 41 is arranged on an upper surface portion of the dashboard 40, a steering wheel support shaft 42 projects upwardly from a rear portion of the meter panel 41, a steering wheel 43 is mounted on an upper end portion of the steering wheel support shaft 42, and a driver seat 44 is arranged rearward of the steering wheel 43 and directly above the transmission portion 4.

Further, on left and right port ions of the transmission portion 4, stepped portions 45, 45 of the driver portion 5 are formed in a state that each stepped portion 45 bulges outwardly and, at the same time, a pair of left and right fender portions 46, 46 is formed on rear end portions of the respective stepped portions 45, 45 in an extending manner so as to cover front sides and upper sides of the left and right rear wheels 9, 9.

Due to such a constitution, the operator can operate the tractor by gripping the steering wheel 43 in a state that the operator places his/her both legs on the stepped portions 45, 45 while sitting on the driver seat 44.

The tractor structure according to the present invention is effectively applicable the structure in which the radiator including the outside-air suction fan is arranged frontward of the engine, the outside-air suction fan and the radiator are covered with the bonnet and, at the same time, the radiator is cooled by sucking the outside air using the outside -air suction fan through the front grille portion formed in the bonnet.

What is claimed is:

1. A tractor in which a radiator including an outside-air suction fan is arranged frontward of an engine, the radiator and the outside-air suction fan are covered with a bonnet, and the outside air is sucked by the outside-air suction fan through a front grille portion formed in the bonnet thus cooling the radiator, wherein
a radiator cooling air discharge opening portion is formed in a side wall portion of the bonnet, and the radiator cooling air discharge opening portion opens in the rearward direction.

2. A tractor according to claim 1, wherein a stepped recessed portion which has a front portion thereof arranged on an outer side of the bonnet and a rear portion thereof arranged on an inner side of the bonnet is formed on the side wall portion of the bonnet,
the radiator cooling air discharge opening portion is formed in an end surface of a stepped portion of the stepped recessed portion, and
a guide surface portion for guiding a radiator cooling air which is discharged through the radiator cooling air discharge opening portion is formed on the side wall portion of the bonnet arranged rearward of the radiator cooling air discharge opening portion, and
the guide surface portion is formed of an inclined surface which extends toward a rear side from a front side with the rear side gradually bulging outwardly.

3. A tractor according to claim 1, wherein the radiator cooling air discharge opening portion is formed in the vertically extending manner with a width thereof gradually increased toward a lower end portion thereof from an upper end portion thereof.
